(19) United States
(12) Patent Application Publication
(10) Pub. No.: US 2023/0131408 A1
(43) Pub. Date: Apr. 27, 2023

(54) FAN BLADE ASSEMBLY

(71) Applicant: Taurus Technologies Holdings, Inc., Barrington, IL (US)

(72) Inventors: Marta Magnusson, Grimsby (CA); Stefan Magnusson, Grimsby (CA)

(73) Assignee: Taurus Technologies Holdings, Inc., Barrington, IL (US)

(21) Appl. No.: 17/972,778

(22) Filed: Oct. 25, 2022

Related U.S. Application Data
(60) Provisional application No. 63/271,679, filed on Oct. 25, 2021.

(51) Int. Cl. B64C 11/02; F16C 32/06

(52) U.S. Cl. CPC B64C 11/02; F16C 32/0603

(57) ABSTRACT

A fan blade assembly using air bearing features to reduce frictional losses, reduce physical wear and tear, and allow for faster acceleration of the fan blade within the assembly is disclosed. A fan blade housing incorporates inlets for pressurized air which create a pressurized area between the fan blade and the housing. The pressurized area functions as an air bearing interface and the fan blade is kept at a controlled distance from the fan blade housing as it spins. In an alternate embodiment, the fan blade assembly has pass-through inlets which use air pressure generated by the fan itself as it spins to provide the pressurized air for the pressurized area.

This invention relates to a fan blade with integral features, including air bearing features which allow the blade to interface with a housing assembly using partial or complete air bearing interfaces, reducing or eliminating mechanical contact with the housing and thus reducing or eliminating mechanical wear and greatly reducing frictional energy losses.

### PRIORITY CLAIM/CROSS-REFERENCE TO RELATED APPLICATIONS

This application claims priority from U.S. Provisional Pat. Application No. 63/271,679, “FAN BLADE ASSEMBLY,” filed on Oct. 25, 2021. The disclosure of the referenced provisional application is herein incorporated by reference.

### BACKGROUND OF THE INVENTION

The present invention relates to a fan blade assembly. Fan blade assemblies, such as those used in drone aircraft, are well known in the art. A motor is used to rotate a fan blade which pushes air in a single direction, creating lift or thrust. Such assemblies can also be used to move heated air away from something which is to be cooled or toward something which is to be heated.

Fan blade assemblies usually use some form of roller bearing to bear the load/interface the physical structure of the fan blade with the fan blade housing. This bearing generates heat and is subject to wear and tear. It also limits how quickly the fan blade can be brought up to speed as excessive acceleration can wear the bearings unevenly or cause bearing failure.

A fan blade assembly which did not rely upon roller bearings to bear the load/interface the physical structure of the fan blade would be a useful invention.

Specifically, a fan blade assembly which used air pressure to form an air bearing between the fan blade and the fan blade housing would be a useful invention.

Furthermore, a fan blade assembly which incorporated its own means of providing air pressure to form an air bearing between the fan blade and the fan blade housing would be a useful invention.

The present invention addresses these concerns.

### SUMMARY OF THE INVENTION

Among the many objectives of the present invention is the provision of a fan blade assembly which does not rely upon roller bearings to bear the load/interface the physical structure of the fan blade within the fan blade assembly.

Another objective of the present invention is to provide a fan blade assembly which uses air pressure to form an air bearing between the fan blade and the fan blade housing to reduce wear and tear and lower frictional energy losses.

Yet another objective of the invention is to provide a fan blade assembly which incorporates its own means of providing air pressure to form an air bearing between the fan blade and the fan blade housing to reduce wear and tear and lower frictional energy losses.

Other objectives and advantages of the present invention will become apparent to those of ordinary skill in the art upon review of the disclosure hereof.

### BRIEF DESCRIPTION OF THE DRAWINGS

FIG. 1 depicts an overhead perspective view of a first embodiment of the fan blade assembly.

FIG. 2 depicts a cutaway overhead perspective view of the first embodiment of the fan blade assembly.

FIG. 3 depicts a cutaway view of the air bearing features of the first embodiment of the fan blade assembly.

FIG. 4 depicts a second cutaway view of the air bearing features of the first embodiment of the fan blade assembly.

FIG. 5 depicts a perspective cutaway view of the air bearing features of the first embodiment of the fan blade assembly.

FIG. 6a depicts a cutaway view of the second embodiment of the fan blade assembly.

FIG. 6b depicts a cutaway view of the air bearing features of a second embodiment of the fan blade assembly.

FIG. 7 depicts a cutaway view of the air bearing features of the second embodiment of the fan blade assembly.

FIG. 8a depicts a cutaway view of the air bearing features of a third embodiment of the fan blade assembly.

FIG. 8b depicts a cutaway view of the air bearing features of the third embodiment of the fan blade assembly.

FIG. 9 depicts an overhead cutaway view of the air bearing features of the third embodiment of the fan blade assembly.

FIG. 10a depicts a side perspective cutaway view of the air bearing features of the third embodiment of the fan blade assembly.

FIG. 10b depicts an alternate side perspective cutaway view of the air bearing features of the third embodiment of the fan blade assembly.

FIG. 11 depicts a detailed cutaway view of the air bearing features of the fan blade assembly.

### DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, can be used with respect to the drawings. These and similar directional terms are not to be construed to limit the scope of the invention in any manner. The words attach, connect, couple, and similar terms with their inflectional morphemes do not necessarily denote direct or intermediate connections, but can also include connections through mediate elements or devices.

Though useful for many applications, the invention will be described as a fan blade assembly intended for use in an aeronautical application such as to provide lift and/or thrust to an aircraft capable of Vertical Takeoff and Landing (VTOL) or Vertical and/or Short Takeoff and Landing (VSTOL.) It will be apparent to persons of ordinary skill in the art that the fan blade assembly can also be used in conventional aircraft or in any other suitable application that requires air to be moved in a controlled direction.

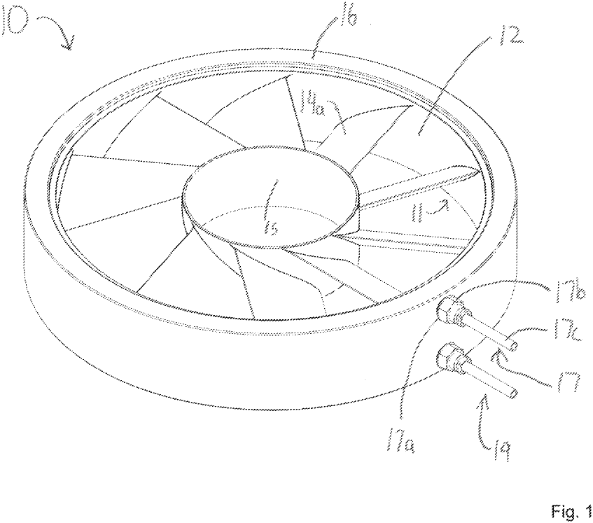

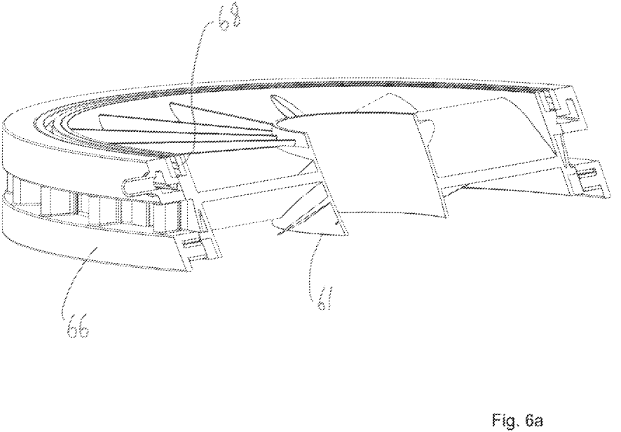

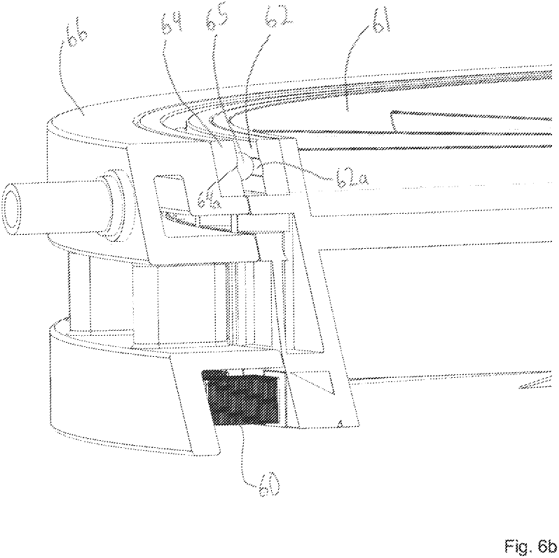

By referring to FIG. 1, the fan blade assembly can be easily understood. Fan blade 11 comprises hub 15, vanes such as vane 14a, and rim 12. Fan blade 11 rotates within fan housing 16 when motivated by a motor or other suitable means (NOT SHOWN, see FIG. 6a for an example.) When fan blade 11 rotates, it forces air to move through fan housing 16, ultimately providing lift/thrust or otherwise moving air as desired for a given purpose.

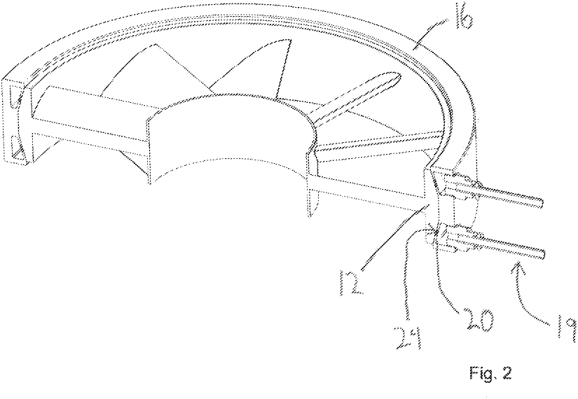

Air sources 17 and 19 provide pressurized air to enable the air bearing feature. (See FIG. 2.) Pressurized air is provided from a source (NOT SHOWN) through air line 17c, which introduces pressurized air into fan housing 16 through air fitting 17a, linked to air line 17c by coupling 17b.

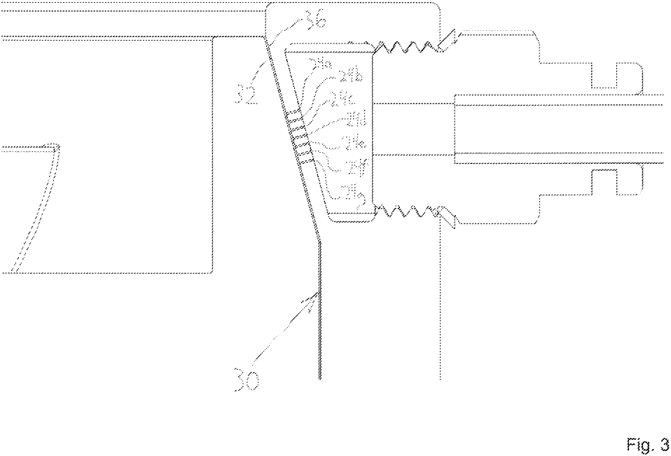

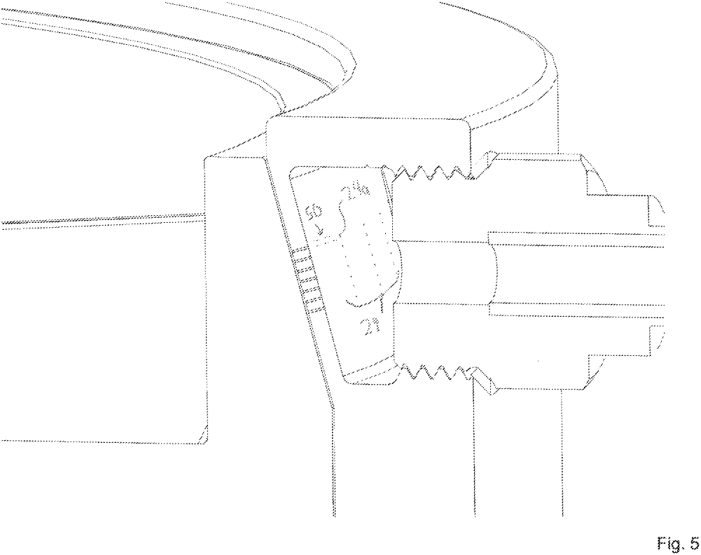

FIG. 2 shows the structure which enables the air bearing feature. Pressurized air is introduced by air source 19 into interior space 20. Interior space 20 communicates with the interface zone between rim 12 and fan housing 20 via air inlets 24. (See FIGS. 3 and 5.) This creates a positive pressure in the interface zone, providing for separation of rim 12 and fan housing 24, enabling the fan blade to rotate freely with no physical contact between the fan blade and the fan housing. This greatly diminishes or removes physical wear and tear caused by friction, reduces loss of energy due to frictional forces, and allows air to move through the fan blade assembly, cooling the entire apparatus.

FIG. 3 shows the air inlets in more detail. Air inlets 24a-24g communicate with interface zone 30, keeping it pressurized. Inner surface 36 of the fan housing is thus kept separate from outer surface 32 of the rim/fan blade. In this configuration, the fan blade pushes against the tapered/angled face of inner surface 36 when it spins up.

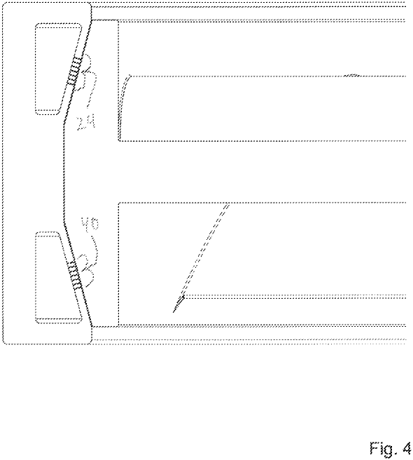

FIG. 4 shows the use of air inlets 24 on the upper area of the fan housing and lower air inlets 40 on the lower area of the fan housing, providing symmetrical pressurization of the interface zone.

FIG. 5 shows the air inlets 24 in more detail. Each air inlet, e.g. air inlet 24a, communicates with the interface zone via through holes, e.g. through hole 50. The through holes can be placed by any convenient means, including but not limited to being cast in place, being printed in place on a 3-D Printer, being mechanically bored, or being bored by energetic means such as a laser or plasma cutter.

FIG. 6a shows a second embodiment of the invention which includes both the air bearing feature and a roller bearing feature. Fan blade 61 and fan housing 66 include the air bearing feature as previously disclosed and a roller bearing 68 (See FIG. 6b.)

FIG. 6b shows the roller bearing in more detail. Inner race 64, which is part of or operationally affixed to fan housing 66, has inner raceway 64a. Outer race 62, which is part of or operationally affixed to fan blade 61, has outer raceway 62a. Ball 65 fits between the inner raceway and the outer raceway, providing a roller bearing feature. Ball 65 is shown as an example: it is required that there be a sufficient number of balls to provide a smooth and symmetrical roller bearing feature. Ball 65 is shown as a sphere, but may be shaped as appropriate: the balls or other rolling elements are also referred to as “roller elements” herein.

It is optional to provide that sufficient pressure is maintained in the interface zone once the fan is spinning to release some or all of the load on the roller bearing feature. In such a configuration, the purpose of the roller bearing is to ensure that the proper distance/spacing is maintained between the fan blade and the fan housing, along with an appropriate bearing feature, even when the air source is turned off or fails, or at startup if it is desired to get the fan up to speed while or before the air bearing feature is being actuated by pressurized air. Alternatively, the roller bearing can be allowed to maintain some significant amount of load, helping to keep the fan blade and fan housing at the proper separation and providing mechanical protection against sudden shocks, etc., which might cause the air bearing feature to fail to maintain the proper spacing. In a second alternative configuration, the air bearing can be allowed to maintain essentially all of the load, “essentially all” meaning that the amount of load borne by the roller bearing is just enough to keep the roller elements in full contact with the raceways, but not enough to allow them to bear any material portion of the load.

Also shown is an abstracted piezoelectric actuator 60 which can drive fan blade 61 when properly configured, such as is disclosed in U.S. Pat. Application 16/941,477, “Piezoelectric Motor,” to Magnusson et al, filed Jul. 28, 2020.

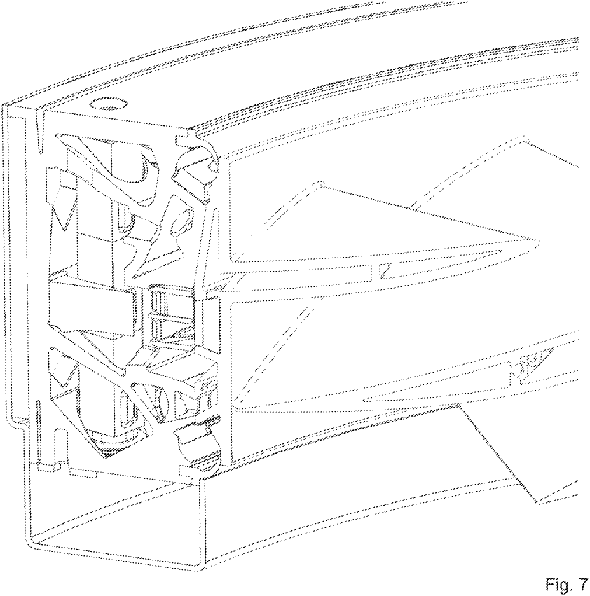

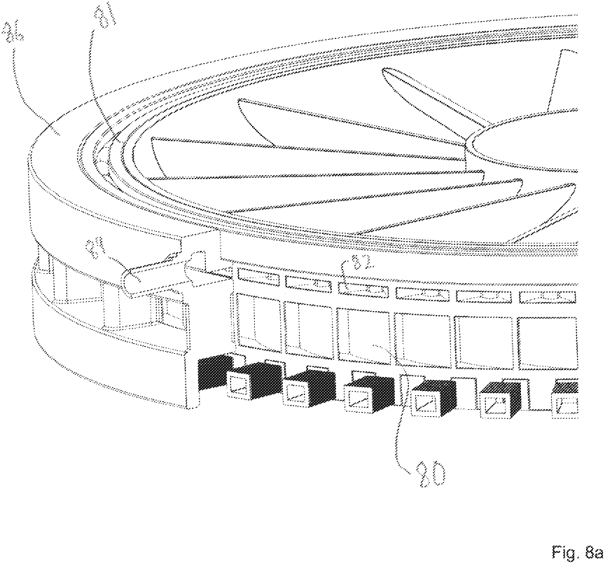

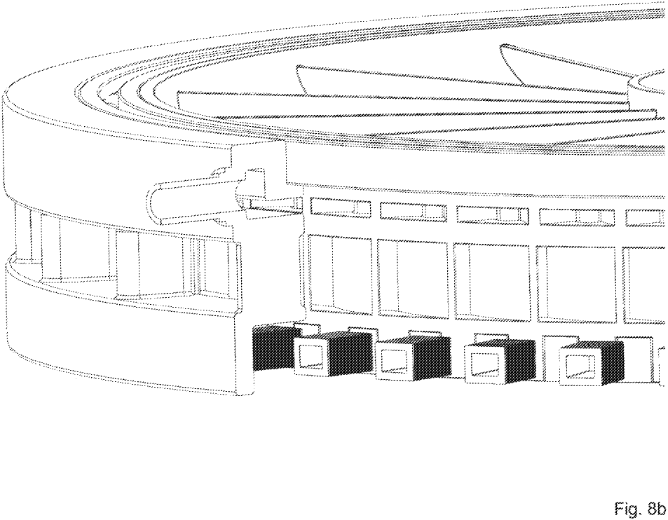

FIG. 7 shows a third embodiment of the invention. The individual elements of this embodiment are further described below (See FIGS. 8a and 8b.) It is optional, but not required, to add one or more piezoelectric, mechanical, electronic, hydraulic, pneumatic, or other appropriate actuators which can mechanically push the races apart to reduce or remove the load on the roller bearing. This configuration is shown in FIG. 7.

FIG. 8a shows a detailed view of the third embodiment of the invention. Fan blade 81 incorporates air intakes, e.g. air intake 82, which gather air from air source 89 as fan blade 81 spins. Fan blade 81 also incorporates pressure ports, e.g. pressure port 80, which are in communication with the air intakes. When air source 89 provides pressurized air to the air intakes, pressurized air is forced out of the pressure ports. This causes a positive pressure in the interface zone between the fan blade and the fan housing, enabling the air bearing feature as previously disclosed.

FIG. 8b shows a closer view of the third embodiment of the invention and is provided only for additional illustration of this embodiment of the invention.

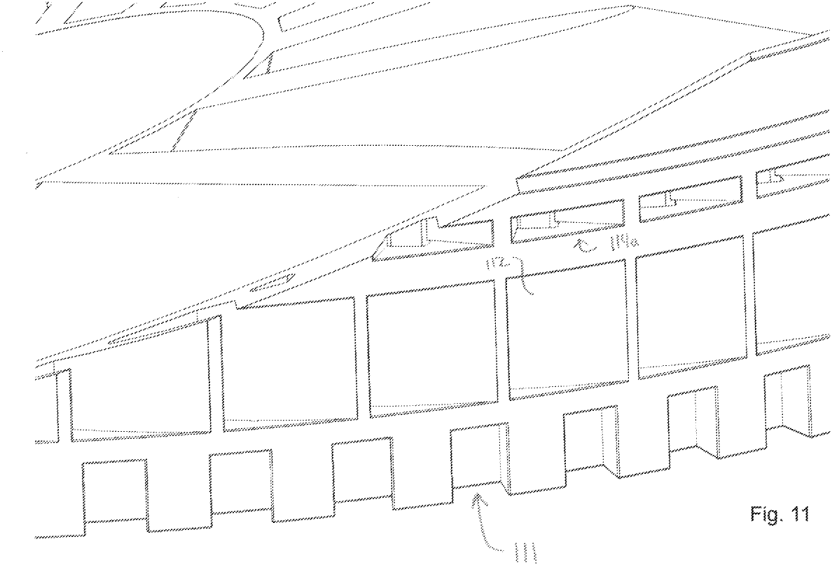

As with most of the embodiments of the invention, if a roller bearing feature is included in the fan blade assembly, the source of pressurized air can be the movement of the fan blade itself (see FIG. 11) creating some volume of positive pressure which is used to feed pressurized air into the interface zone. If a roller bearing is used, it is optional to provide additional pressurized air to the system over and above that provided by the movement of the fan blade. Such additional source can be used to help ease the load on the roller bearing at startup, during transient accelerations, and/or when high levels of lift/thrust are required and the fan blade is rotating at high velocity.

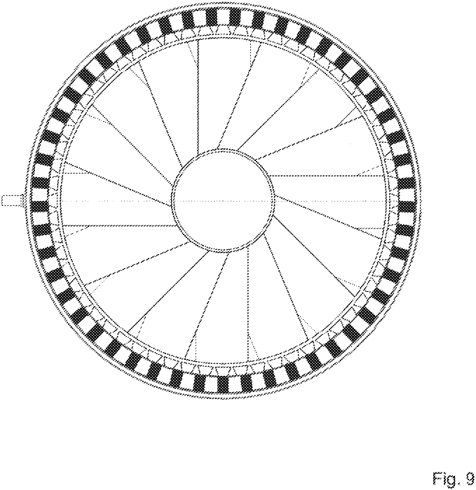

FIG. 9 shows an overhead view of the third embodiment of the invention and is provided only for illustration of other potential configurations of this embodiment.

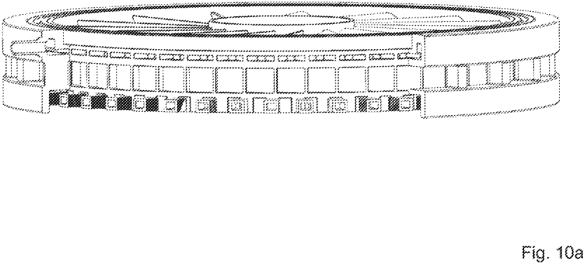

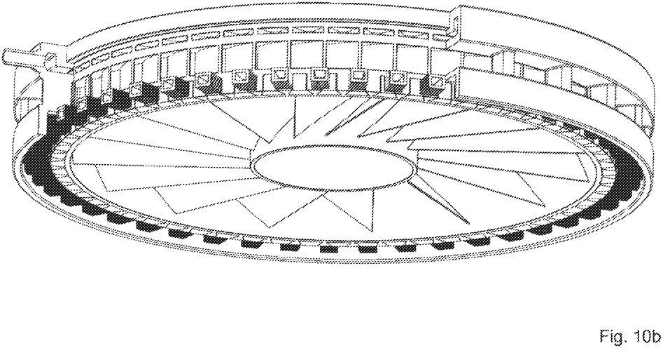

FIGS. 10a and 10b show an alternate view of the third embodiment of the invention and is provided only for illustration of other potential configurations of this embodiment.

FIG. 11 shows more details of the optional self-pressurizing feature of the invention. Air, from whatever source, enters intake 114a and goes into pressure port 112 of fan blade 111. If the intake is configured such that when the fan is rotating, air is forced into it, the air thus forced into it will be used to create a positive pressure in the interface zone when it emerges from pressure port 112. Fan blade 111 can be configured with “scoops” or otherwise configured to increase or maximize the amount of air that flows into the air bearing feature and maintains the positive pressure between the fan blade and the fan housing.

It will be apparent to those of ordinary skill in the art that the embodiments herein could be combined in varied combination or as a single unit, granting the improvements of each to a single fan blade assembly.

While various embodiments and aspects of the present invention have been described above, it should be understood that they have been presented by way of example only, and not limitation. Thus, the breadth and scope of the present invention should not be limited by any of the above exemplary embodiments.

This application — taken as a whole with the abstract, specification, and drawings being combined — provides sufficient information for a person having ordinary skill in the art to practice the invention as disclosed herein. Any measures necessary to practice this invention are well within the skill of a person having ordinary skill in this art after that person has made a careful study of this disclosure.

Because of this disclosure and solely because of this disclosure, modification of this device and method can become clear to a person having ordinary skill in this particular art. Such modifications are clearly covered by this disclosure.

What is claimed is:

1. A fan blade assembly comprising:
a) a fan blade, the fan blade having an outer surface;
b) a fan housing, the fan housing having an inner surface, the inner surface in operational proximity to the outer surface such that the fan blade can rotate within the fan housing;
c) one or more air inlets in the outer surface which communicate with an interface zone, the interface zone comprising a space between the inner surface and the outer surface; and
d) a source of pressurized air operably communicating with the air inlets, such that the source of pressurized air can create a positive pressure in the interface zone.

2. The fan blade assembly of claim 1, wherein the source of pressurized air comprises one or more air intakes which are pressurized by air moved by the fan blade when the fan blade is rotating within the fan housing.

3. The fan blade assembly of claim 1, further comprising:
e) an inner race, the inner race being part of or operationally affixed to the fan housing;
f) an outer race, the outer race being part of or operationally affixed to the fan blade such that the inner race and the outer race are in operational proximity to each other; and,
g) one or more roller elements, the roller elements being located between the inner race and the outer race such that when the fan blade rotates within the fan housing, the roller elements maintain the space between the fan blade and the fan housing and bear some or all of a mechanical load comprising the fan blade.

4. The fan blade assembly of claim 2, further comprising:
e) an inner race, the inner race being part of or operationally affixed to the fan housing;
f) an outer race, the outer race being part of or operationally affixed to the fan blade such that the inner race and the outer race are in operational proximity to each other; and,
g) one or more roller elements, the roller elements being located between the inner race and the outer race such that when the fan blade rotates within the fan housing, the roller elements maintain the space between the fan blade and the fan housing and bear some or all of a mechanical load comprising the fan blade.

5. The fan blade assembly of claim 1, wherein the fan blade incorporates one or more blade air intakes which are pressurized by air moved by the fan blade when the fan blade is rotating within the fan housing, the blade air intakes communicating with the interface zone such that the interface zone is provided with pressurized air by the blade air intakes.

6. The fan blade assembly of claim 2, wherein the fan blade incorporates one or more blade air intakes which are pressurized by air moved by the fan blade when the fan blade is rotating within the fan housing, the blade air intakes communicating with the interface zone such that the interface zone is provided with pressurized air by the blade air intakes.

7. The fan blade assembly of claim 3, wherein the fan blade incorporates one or more blade air intakes which are pressurized by air moved by the fan blade when the fan blade is rotating within the fan housing, the blade air intakes communicating with the interface zone such that the interface zone is provided with pressurized air by the blade air intakes.

8. The fan blade assembly of claim 4, wherein the fan blade incorporates one or more blade air intakes which are pressurized by air moved by the fan blade when the fan blade is rotating within the fan housing, the blade air intakes communicating with the interface zone such that the interface zone is provided with pressurized air by the blade air intakes.

9. The fan blade assembly of claim 1, wherein the source of pressurized air comprises a pressurized tank of air.

10. The fan blade assembly of claim 2, wherein the source of pressurized air comprises a pressurized tank of air.

11. The fan blade assembly of claim 1, wherein the source of pressurized air comprises an air intake system which becomes pressurized when a vehicle in which the fan blade assembly is mounted moves through a volume of air.

12. The fan blade assembly of claim 2, wherein the source of pressurized air further comprises an air intake system which becomes pressurized when a vehicle in which the fan blade assembly is mounted moves through a volume of air.

13. The fan blade assembly of claim 9, wherein the source of pressurized air further comprises an air intake system which becomes pressurized when a vehicle in which the fan blade assembly is mounted moves through a volume of air.

14. The fan blade assembly of claim 10, wherein the source of pressurized air further comprises an air intake system which becomes pressurized when a vehicle in which the fan blade assembly is mounted moves through a volume of air.

15. The fan blade assembly of claim 3, wherein the source of pressurized air comprises a pressurized tank of air.

16. The fan blade assembly of claim 4, wherein the source of pressurized air comprises a pressurized tank of air.

17. The fan blade assembly of claim 3, wherein the source of pressurized air comprises an air intake system which becomes pressurized when a vehicle in which the fan blade assembly is mounted moves through a volume of air.

18. The fan blade assembly of claim 4, wherein the source of pressurized air further comprises an air intake system which becomes pressurized when a vehicle in which the fan blade assembly is mounted moves through a volume of air.

19. The fan blade assembly of claim 3, such that when the interface zone is subject to the positive pressure, some but not all of the mechanical load is borne by the roller elements.

20. The fan blade assembly of claim 4, such that when the interface zone is subject to the positive pressure, essentially all of the mechanical load is borne by the roller elements.
